(19) United States
(12) Patent Application Publication
(10) Pub. No.: US 2026/0330474 A1
(43) Pub. Date: Oct. 22, 2026

(54) METHODS AND SYSTEMS TO ACHIEVE AUTO SAFETY INTEGRITY LEVEL B AND D FOR SAFETY WARNING SIGN AND SOUND SYSTEM

(71) Applicant: Samsung Electronics Co., Ltd., Gyeonggi-do (KR)

(72) Inventors: Xiao SUN, Austin, TX (US); Kilhyung CHA, Sunnyvale, CA (US)

(21) Appl. No.: 19/306,586

(22) Filed: Aug. 21, 2025

Related U.S. Application Data
(60) Provisional application No. 63/790,446, filed on Apr. 17, 2025.

(51) Int. Cl. G06Q 30/018

(52) U.S. Cl. CPC G06Q 30/018

(57) ABSTRACT

Methods and systems for verifying safety compliance of Safety Warning Sound and Graphic Sign systems to achieve ASIL B or D level in automotive and robotics applications. The method includes providing a predetermined safety warning sign and sound set comprising graphic symbols and auditory signals, transmitting commands to hardware components such as a display processing unit (DPU) and an audio unit (AUD) to generate the safety warning outputs, and capturing output data including displayed frames and sound clips. A neural processing unit (NPU) processes the captured data using a pre-trained inference model generated from the safety warning set and valid sensor data. The processed data is compared against predetermined safety criteria to detect deviations, triggering error reporting and hardware reset commands if necessary. The system supports over-the-air updates, multi-layered display composition, and adaptive sound mixing, ensuring compliance with safety standards under varying environmental conditions.

### CROSS-REFERENCE TO RELATED APPLICATION

This application claims the priority benefit under 35 U.S.C. § 119(e) of U.S. Provisional Application No. 63/790,446, filed on Apr. 17, 2025, the disclosure of which is incorporated by reference in its entirety as if fully set forth herein.

### TECHNICAL FIELD

The disclosure generally relates to safety requirements of automotive systems and/or robotics. More particularly, the subject matter disclosed herein relates to improvements to system-on-chip (SoC) design for providing safety warnings.

### SUMMARY

Automotive safety integrity level (ASIL) is a risk classification system defined by the International Organization for Standardization (ISO) 26262 standard for functional safety. ASIL safety levels, which range from A to D, are used to assess the safety requirements of automotive systems, including robotics. ASIL D represents the highest level of risk and therefore the most stringent safety requirements, while ASIL A represents the lowest level of risk. ASIL levels are determined through a hazard analysis and risk assessment (HARA), considering factors like severity of harm, likelihood of exposure, and controllability of the hazardous situation.

Recently, the demand for safety warning sound and graphic sign systems to compose and display safety warning signs (e.g., a display processing unit (DPU)) and safety warning sounds (e.g., audio (AUD)) has increased dramatically for automotive and/or industrial application (such as a robot or a humanoid robot) safety SoCs.

A DPU has functionality to compose many layers together for multiple displays. A DPU has functionality to blend or merge multiple layers of display from various of sources, for example, a background layer, non-safety related information such as icons for volume adjustment, icons for audio sources, settings of car, etc., and safety related layers which can be safety instruments such as speed, level of energy left as well safety warning symbols, etc. A safe warning sign is 99.9% visible by the design of DPU composition system.

An AUD unit can mix safety warning sound with a regular sound (such as robot's regular conversation with a human or with another robot, or car entertainment sound) with a high signal (safe warning sound) to noise (S/N) ratio as the mixed sound could be with 0% environment noises (but not limited thereto) and a mixture ratio designed by the system to guarantee that safe warning sound is 99.9% auditable. This is to give visual and audio warnings to an operator (e.g., a driver, a robot supervisor, a human interacting with a robot, etc.). However, there is a hardware cost to producing a safety warning sound and graphic sign system to meet the various functional safety levels, such as ASIL B, wherein a malfunction can cause non-serious human body injury or life-threatening consequences, or ASIL D, wherein a malfunction can cause serious human body injury or life-threatening consequences, due to both complex safety warning sound and graphic sign hardware architecture and software collaterals. For example, an auto in-vehicle infotainment (IVI) SoC can have ASIL B safety goal for a safety warning sound and graphic sign system, but a moving humanoid robot interacting with a human being may require ASIL D as a safety goal for safety warning sound and graphic sign system.

More specifically, safety warning sound and graphic sign system ASIL D challenges may include:
It can take an extra 100% silicon area overhead to make safety warning sound and graphic sign system hardware to reach ASIL D metric (i.e., single permanent fault coverage (SPFC)>99%, latent fault (LF)>90%) and it also causes lower performance and higher power drain.
It requires spatial isolation to achieve the safety ASIL D goals (e.g., lock-step independently implemented physical design if permanent fault occurs) for freedom of interference (FFI).
It may take a large amount of research and development on functional verification and fault campaign to achieve an ASILD safety goal if no end-to-end system level checker or no lock-step independently implemented physical design duplication (100% area growth) is feasible.

Further, safety warning sound and graphic sign system ASIL B challenges may include:
It can take an extra 5%-30% area overhead to make Safety Warning Sound and Graphic Sign HW reach ASIL B metric (requirement: SPFM (Single Permanent Fault Coverage)>90%, LFM (Latent Fault)>60%) and cause lower performance and higher power drain during frame gap.
It requires spatial isolation to achieve the safety of ASIL B for freedom of interference (FFI).

Safety warning sound and graphic sign software should also to be certified to ASIL B or D, which can take longer than hardware certification.

In automotive and robotic SoCs, there may be a hardware acceleration block such as a neural processing unit (NPU) for inferencing tasks such as objects and object recognitions to provide intelligence to interact with the surrounding environment. However, the SoCs are not limited to an NPU, i.e., other interference capable hardware such as a digital signal processor (DSP), a graphic processing unit (GPU), or a G-GPU may be utilized.

The SoCs may also include an ASIL B or D central processing unit (CPU) to compare safety results.

To overcome these types of issues, systems and methods are described herein for using an ASIL B or D NPU and CPU hardware to conduct end-to-end checks on a safety warning sound and graphic sign system.

Additionally, systems and methods are described herein, wherein an NPU can perform inference from a safety warning sign and sound to recognize objects, and then have a CPU compare whether the safety warning sign and sound produced by the safety warning sound and graphic sign system are correct, i.e., as intended, or not.

Additionally, systems and methods are described herein, which use existing safety-compliant SoC hardware components to conduct end-to-end safety checks on functions produced by non-safety-compliant hardware components.

The above approaches improve on previous methods because there is no hardware area increase (smaller die size), no fault campaign effort, less software certification work (time and resource), and no design and verification resources needed to achieve ASIL B or D goals on AUD and DPU design.

In an embodiment, a method for verifying safety compliance of a safety warning sound and graphic sign system for achieving ASIL B or D level is provided, the method including providing a predetermined safety warning sign and sound set comprising predetermined graphic symbols and auditory signals for alerting an operator; transmitting, by a processor, a command to safety warning sign and sound hardware including a display processing unit (DPU) and an audio unit (AUD) to generate the safety warning sign on a display and the safety warning sound through speakers in accordance with the predetermined safety warning sign and sound set; capturing output data, the output data including an output frame of the displayed safety warning sign and a corresponding sound clip of the safety warning sound from the safety warning sign and sound hardware; processing the captured output data using a neural processing unit (NPU) executing a pre-trained inference model generated from the predetermined safety warning sign and sound set, and valid sensor data; comparing the processed output data with predetermined safety criteria corresponding to the predetermined safety warning sign and sound set; and in response to detecting a deviation between the processed output data and the predetermined safety criteria, reporting an error signal, and issuing a reset command to the safety warning sign and sound hardware, whereby the method provides an end-to-end checking mechanism ensuring that the safety warning sign and sound output meets ASIL B or D safety requirements.

In an embodiment, a safety warning sound and graphic sign system for achieving ASIL B or D level is provided, the system including a predetermined safety warning sign and sound set comprising predetermined graphic symbols and corresponding auditory signals for alerting an operator; a safety warning sign and sound hardware configured to: generate the safety warning sign on a display via a display processing unit (DPU) and the safety warning sound through an audio unit (AUD) based on the predetermined safety warning sign and sound set, compose multiple display layers, and mix the safety warning sound with a baseline audio signal in a defined ratio; a neural processing unit (NPU) operatively coupled to the safety warning sign and sound hardware and configured to: receive output data from the safety warning sign and sound hardware, process the output data using a pre-trained inference model generated from the predetermined safety warning sign and sound set and valid sensor data, and identify deviations in the output data from predetermined safety criteria; a central processing unit (CPU) operatively coupled to the safety warning sign and sound hardware and the NPU, the CPU configured to: transmit commands to the safety warning sign and sound hardware for generating the safety warning sign and sound in accordance with the predetermined safety warning sign and sound set, and compare the processed output data from the NPU with the predetermined safety criteria; and a fault management module operatively coupled to the CPU and the safety warning sign and sound hardware, the fault management module configured to: receive a deviation signal when the processed output data fails to meet the predetermined safety criteria, and issue a reset command to the safety warning sign and sound hardware in response.

### BRIEF DESCRIPTION OF THE DRAWING

In the following section, the aspects of the subject matter disclosed herein will be described with reference to exemplary embodiments illustrated in the figures, in which:

FIG. 1 is a safety warning sound and graphic sign system for achieving ASIL B or D level, according to an embodiment.

FIG. 2 is flowchart for a method for verifying safety compliance of a safety warning sound and graphic sign system for achieving ASIL B or D level, according to an embodiment.

FIG. 3 is a flow diagram illustrating a method for online ASIL B/D model generation, according to an embodiment.

FIG. 4 is a flow diagram illustrating a method for offline ASIL B/D model generation, according to an embodiment.

FIG. 5 is a block diagram of an electronic device in a network environment, according to an embodiment.

FIG. 6 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so fort

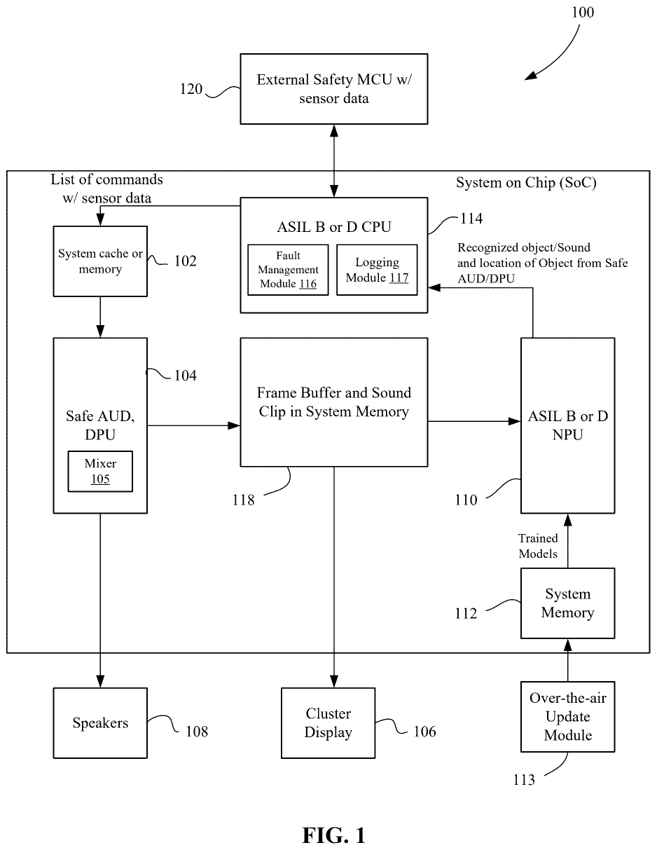

FIG. 1 depicts an exemplary safety warning sound and graphic sign system 100 for achieving ASIL B or D level. The system 100 includes a predetermined safety warning sign and sound set comprising predetermined graphic symbols and corresponding auditory signals for alerting an operator stored in a system cache or memory 102. Safety warning sign and sound hardware 104 is configured to generate the safety warning sign on a display 106 via a display processing unit (DPU) and the safety warning sound via speaker 108 through an audio unit (AUD) based on the predetermined safety warning sign and sound set. The safety warning sign and sound hardware 104 composes multiple display layers, and mixes the safety warning sound with a baseline audio signal in a defined ratio. In one embodiment, the safety warning sign and sound hardware 104 further includes a mixer circuit configured to mix the safety warning sound with the baseline audio signal at a defined ratio, the defined ratio being selected to ensure the audibility of the safety warning sound under varying ambient noise conditions.

A neural processing unit (NPU) 100 is operatively coupled to the safety warning sign and sound hardware 104 and configured to receive output data from the safety warning sign and sound hardware 104, process the output data using a pre-trained inference model (e.g., stored in system memory 112) generated from the predetermined safety warning sign and sound set and valid sensor data, and identify deviations in the output data from predetermined safety criteria. The NPU 100 is further configured to extract feature data from the output data received from the safety warning sign and sound hardware 104 and use the extracted feature data to enhance the detection of deviations from the predetermined safety criteria.

The system 100 further includes a central processing unit (CPU) 114 operatively coupled to the safety warning sign and sound hardware 104 and the NPU 110. The CPU 114 is configured to transmit commands to the safety warning sign and sound hardware 104 for generating the safety warning sign and sound in accordance with the predetermined safety warning sign and sound set and compare the processed output data from the NPU 110 with the predetermined safety criteria. In one embodiment, the checking/comparison needs to be completed in a predetermined frame gap (e.g., 30 fps with 33.3 ms frame gap is an acceptable FDTI (Fault Detection Time Interval) for Auto SOCs FDTI+FRTI=FHTI<FTTI (Fault Tolerant Time Interval, 100-500 ms depending on use cases).

A fault management module 116 is operatively coupled to the CPU 114 and the safety warning sign and sound hardware 104. In one embodiment, the fault management module may be disposed in or be a part of the CPU 114. The fault management module 116 is configured to receive a deviation signal when the processed output data fails to meet the predetermined safety criteria and issue a reset command to the safety warning sign and sound hardware 104 in response. In one embodiment, the system 100 further includes a logging module 117 configured to record occurrences of deviations detected by the NPU 110 and corresponding diagnostic information associated with the recorded occurrences. It is to be appreciated that the logging module 117 may be disposed in CPU 114 or disposed on a different portion of the SoC.

According to an embodiment, the sensor data is external of the system 100 through an external safety MCU 120 and sensor data can be any safety critical instrument data to be shown via safety cluster display dials and safety camera/radar to detect objects (cars or humans, speed and relative positions to the car (front, left or right or back)) around the car with this SOC).

It is to be appreciated that the NPU 110 has a pre-trained inferencing model from a given predetermined safety object and sound set and a list of valid sensor data. The CPU 114 and safety warning sound and graphic sign hardware 104 have the same given predetermined safety object & sound set and a list of valid sensor data. The NPU 110 knows the safety display area and pixel size (coordinates), and also the safety sound paths. Color, light reflection and light from ray tracing and texture on objects are not safety-related. NPU 110 attempts to recognize the safety event and CPU 114 is detecting for various errors. For example, one error may include missing/extra or wrong objects supposed to be generated by safety warning sound and graphic sign hardware 104: missing object example includes a safety warning object &/or sound is missing. Another error may include an extra or wrong object: a car is not supposed to show up or wrong warning object &/or sound but shown by safety warning sound and graphic sign hardware 104 or objects are displayed at a wrong location by safety warning sound and graphic sign hardware 104.

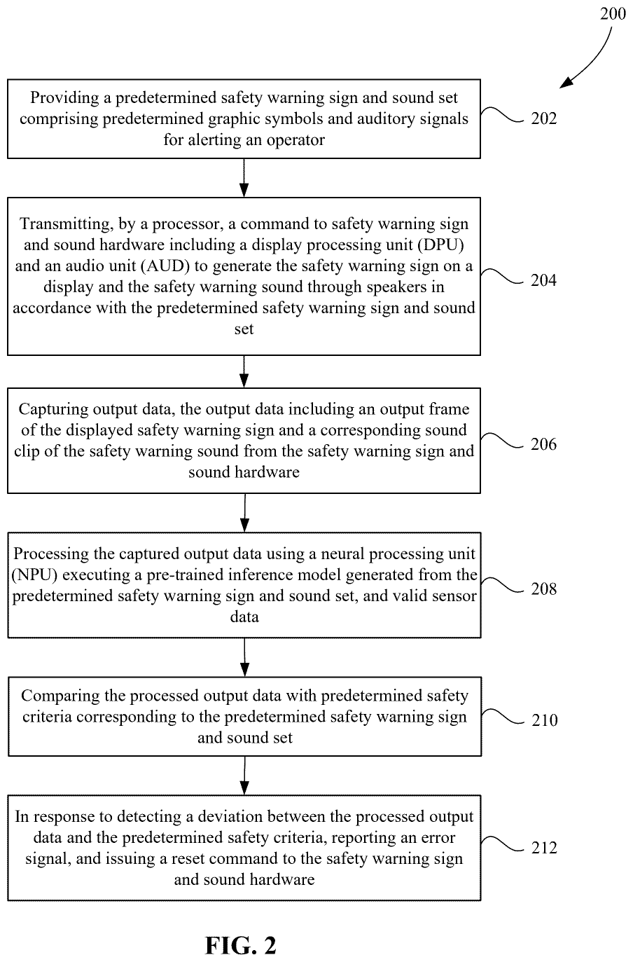

In one embodiment, the system 100 further includes an over-the-air update module configured to automatically download and install updates to the predetermined safety warning sign and sound set based on updated valid sensor data and operational parameters, as will be described in more detail below.
The system 100 of the present disclosure performs as an end-to-end ASILB/D checker to check whether safety warning sound and graphic sign produced are correct according to Safety Warning Sound and Graphic Sign inputs (i.e., safety workload indicated by external safety sensors). The icons and sound of these objects are pre-determined but can be mixed/shown differently in speakers/in 2D display through Safety Warning Sound and Graphic Sign HW (AUD and DPU).
It is to be appreciated that the ASIL B or D NPU 100 has two input sources 1) trained models/coefficients from system memory 112 used for inference work; 2) safety warning sound and graphic sign output frames and sound clip with safety contents from hardware 104. NPU 110 processes safety warning sound and graphic sign outputs through the inferencing engine and then send it to ASIL B or D CPU 114, which is aware of safety warning sound and graphic sign external sensor data to know safety rendering objects and intents to check whether interference results from NPU 110 meet the safety warning sound and graphic sign input intents. If it passes the NPU/CPU check, then safety warning sound and graphic sign system 100 passes the ASIL B or D checker (functioning properly for safety critical mission mode); if it fails the NPU/CPU check, then ASIL B or D CPU 114 would report the error to fault handle/management module 116 and generate an interrupt to reset AUD/DPU 104 and then report to external ASIL B or D MCU 120 so external ASIL B or D MCU 120 can take any further appropriate actions needed.
Modern NPU can detect real-life objects at close to 90% accuracy and can get close to 99.9% accuracy with pre-determined objects (e.g., sound without much noise and graphic sign without noise). Within this context of the use case, safety warning objects and sounds are pre-determined so the training model used for NPU inference can be 99.9% accurate. The system 100 can upgrade/change pre-determined objects/sounds and new trained models via over-the-air updates together. CPU ASIL B or D checker 114 is 100% accurate as the CPU 114 is aware of safety warning sound and graphic sign safety display work. The interference and checking work can achieve an ASIL B metric (requirement: Single Permanent Fault Coverage (SPFM)>90%, Latent Fault (LFM)>60%) and an ASIL D metric (requirement: SPFM>99%, LFM>90%).
Referring to FIG. 2, a method for verifying safety compliance of a safety warning sound and graphic sign system for achieving ASIL B or D level, according to an embodiment, is provided.

In step 202, a predetermined safety warning sign and sound set comprising predetermined graphic symbols and auditory signals for alerting an operator is provided. The safety warning sign is generated by composing multiple display layers, each corresponding to a component of the predetermined safety warning sign and sound set and the corresponding sound clip comprises a mixture of the safety warning sound and a baseline audio signal, the mixture ratio being set to ensure that the safety warning sound remains distinctly audible.

In step 204, CPU 114, transmits a command to the safety warning sign and sound hardware 104 including the display processing unit (DPU) and the audio unit (AUD) to generate the safety warning sign on the display 106 and the safety warning sound through speakers 108 in accordance with the predetermined safety warning sign and sound set. In step 206, output data including an output frame of the displayed safety warning sign and a corresponding sound clip of the safety warning sound from the safety warning sign and sound hardware is captured in the frame buffer and sound clip memory 118.

In step 208, the neural processing unit (NPU) 110 processes the captured output data using executing a pre-trained inference model generated from the predetermined safety warning sign and sound set, and valid sensor data. The NPU 110 extracts feature data from the output frame and the sound clip and generates an object/sound from the pre-trained inference model by applying machine learning techniques to training data that includes the extracted feature data.

In step 210, the processed output data is compared by CPU 114 with predetermined safety criteria corresponding to the predetermined safety warning sign and sound set.

In step 212, in response to detecting a deviation between the processed output data and the predetermined safety criteria, reporting an error signal to the fault management module, and issuing a reset command to the safety warning sign and sound hardware 104, whereby the method provides an end-to-end checking mechanism ensuring that the safety warning sign and sound output meets ASIL B or D safety requirements. The reset command reinitializes the safety warning sign and sound hardware for a subsequent safety compliance verification cycle.

In one embodiment, a log of the captured output data and detected deviations is stored and used for subsequent analysis and safety compliance verification. Additionally, the pre-trained inference model is periodically recalibrated based on updated valid sensor data and captured output data from operational cycles to maintain compliance with the predetermined safety criteria.

An NPU can detect real-life objects at close to 90% accuracy and can get 99.99% accuracy with pre-determined objects. Within this context of use case, warning sign objects and sounds are pre-determined so a training model used for NPU interference can be 99.99% accurate as they do not have noises. Accordingly, pre-determined objects (sign and sound) and new trained models can be upgraded/changed via over-the-air updates together.

Since a fixed type of sign/sound set may be produced by a safety warning sound and graphic sign system on a 2-dimensional (2D) display in an SoC, the same safety warning sound and graphic sign system may be used to train a model for an NPU. The training process can be conducted on off chip high performance discreet GPU farms or on an NPU if performance is adequate for training purpose. The safety objects and sounds produced by auto safety warning sound and graphic sign displayed are predetermined and usually from a limited set, and as such, very feasible for use in such an NPU strategy.

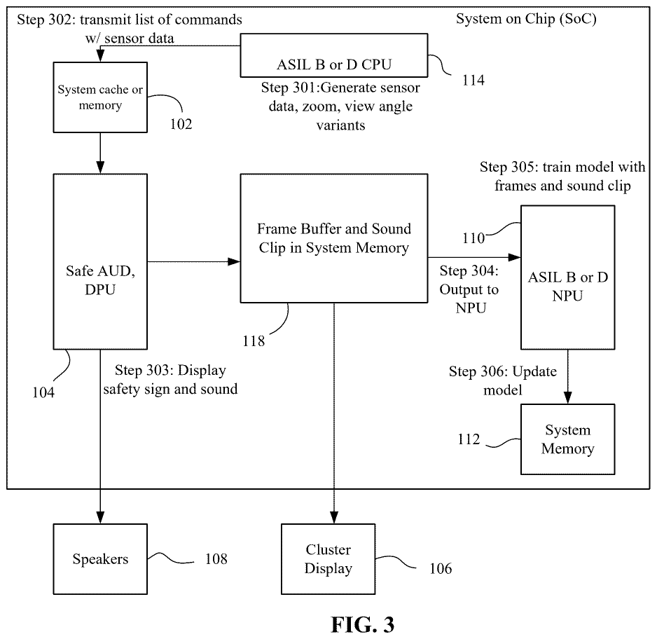

Referring to FIG. 3, a flow diagram illustrating a method for online ASIL B/D model generation, according to an embodiment, is provided. It is to be appreciated that the model may be generated before the SoC is used in the field for a given set of pre-determined safety signs and sound and valid zoom/view angle and orientation variants and all valid sensor data. It is further to be appreciated that valid sensor data may include acceptable or allowable ranges for the data associated to available external sensors. For example, a display has a fixed size, so valid pixel coordinates should be within the display panel dimension; a speed meter can only show either 0 to maximum speed allowed by the car manufacture specification. It is to be appreciated that any negative number is not legal or valid or a front facing camera cannot report objects behind the camera. Distance of a detected object to a camera should be positive but within a reasonable distance determined by the specification, for example, within 1 arm's length is not safe for a robot, but the longest safe distance considered shall be practically reasonable such as between 2 arm's length to 5 arm's length, while 100 arm's length shall be not valid.

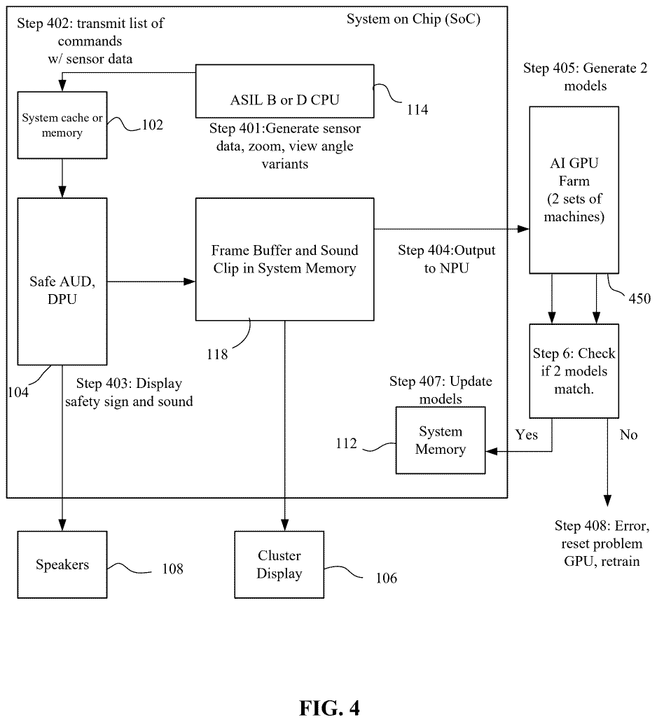

In step 301, CPU 114 generates all possible valid zoom and view angles and orientation variants and all possible valid sensor data information, then forms them one by one as CPU 114 sends jobs to safe AUD and DPU to compose/display safe sign and mixture safe sound with predetermined safety sign and sound. In step 302, CPU 114 sends commands to safety warning sound and graphic sign hardware 104. In step 303, safety warning sound and graphic sign hardware 104 displays safety sign and sound according to CPU commands. In step 304, AUD & DPU of safety warning sound and graphic sign hardware 104 composes layers display and outputs frame is in a frame buffer in system memory, AUD mixes sound and saves into system memory as well. In step 305, the NPU 110 takes the frame and sound clip one by one going through model trainings. As will be described in relation to FIG. 4, this NPU can be external high-performance discrete AI GPU farms. In step 306, NPU or external high-performance discrete AI GPU farms generate a model from the above training purpose and transmits updated model to the system memory 112.

Once the model is generated, then the method described in relation to FIG. 2 may be used to check whether the end-to-end check pass is 100%. Once end-to-end checking is finished, then the trained model is ready to use for field for the given set of pre-determined safety sign and sound object set. The process may then be repeated when a new pre-determined safety sign and sound object is added or exchanged in the previous pre-determined safety sign and sound object set to update the model. For example, the over-the-air update module 113 may receive a new pre-determined safety sign and sound object. The method shown in FIG. 3 may then be performed to update the model, for example, this can be run when an automobile is parked or a robot is charging.

Referring to FIG. 4, a flow diagram illustrating a method for offline ASIL B/D model generation, according to an embodiment, is provided. In this embodiment, an AI GPU farm may be employed to generate a high accuracy inference model. In this embodiment, two sets of AI GPUs are employed to generate two models with the same input set to achieve duplication redundancy of 99.999%, i.e., ASIL D quality level.

In step 401, CPU 114 generates all possible valid zoom and view angles and orientation variants and all possible valid sensor data information, then forms them one by one as CPU 114 sends jobs to safe AUD and DPU to compose/display safe sign and mixture safe sound with predetermined safety sign and sound.

In step 402, CPU 114 sends commands to safety warning sound and graphic sign hardware 104. In step 403, safety warning sound and graphic sign hardware 104 displays safety sign and sound according to CPU commands. In step 404, AUD & DPU of safety warning sound and graphic sign hardware 104 composes layers display and outputs frame in a frame buffer in system memory, AUD mixes sound and saves into system memory as well. In step 405, the frame and sound clips one by one are transmitted to the AI GPU farm 450 including at least two GPUs to generate at least two models. In step 406, the at least two generated models are compared to determine if the models match. If the models match, system memory 112 is updated with the new models, in step 407. If the models do not match, an error is flagged and the GPUs are reset to retrain the models, in step 408, and the method reverts to step 405. In one embodiment, the method may iteratively perform steps 405 through step 408 until the models are successfully updated.

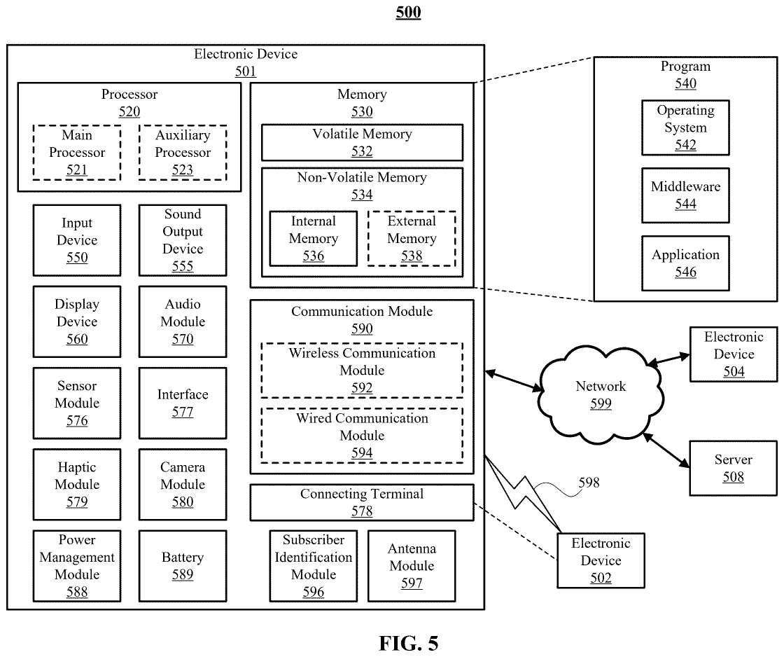

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

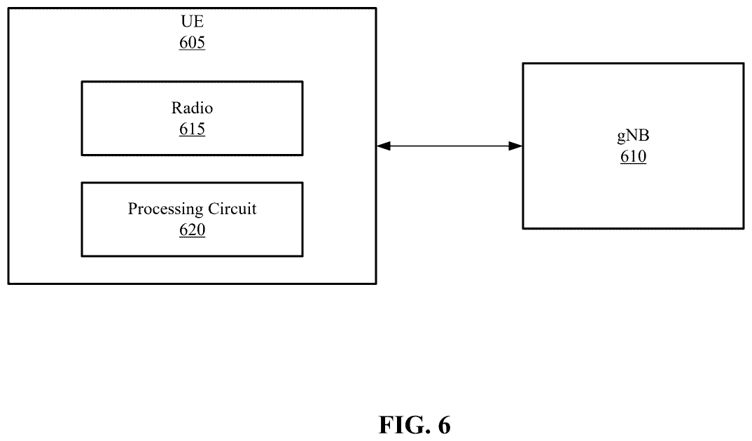

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 1. For example, the processing circuit 620 may receive, via the radio 615, transmissions from the network node (gNB) 610, and the processing circuit 620 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for verifying safety compliance of a safety warning sound and graphic sign system for achieving ASIL B or D level, the method comprising:
providing a predetermined safety warning sign and sound set comprising predetermined graphic symbols and auditory signals for alerting an operator;
transmitting, by a processor, a command to safety warning sign and sound hardware including a display processing unit (DPU) and an audio unit (AUD) to generate the safety warning sign on a display and the safety warning sound through speakers in accordance with the predetermined safety warning sign and sound set;
capturing output data, the output data including an output frame of the displayed safety warning sign and a corresponding sound clip of the safety warning sound from the safety warning sign and sound hardware;
processing the captured output data using a neural processing unit (NPU) executing a pre-trained inference model generated from the predetermined safety warning sign and sound set, and valid sensor data;
comparing the processed output data with predetermined safety criteria corresponding to the predetermined safety warning sign and sound set; and
in response to detecting a deviation between the processed output data and the predetermined safety criteria, reporting an error signal, and issuing a reset command to the safety warning sign and sound hardware,
whereby the method provides an end-to-end checking mechanism ensuring that the safety warning sign and sound output meets ASIL B or D safety requirements.

2. The method of claim 1, wherein the predetermined safety warning sign and sound set is updated via an over-the-air update mechanism to include new predetermined graphic symbols and auditory signals.

3. The method of claim 1, wherein the safety warning sign is generated by composing multiple display layers, each corresponding to a component of the predetermined safety warning sign and sound set.

4. The method of claim 1, wherein the corresponding sound clip comprises a mixture of the safety warning sound and a baseline audio signal, the mixture ratio being set to ensure that the safety warning sound remains distinctly audible.

5. The method of claim 1, further comprising:
capturing valid sensor data from at least one sensor selected from a group consisting of cameras, ambient light sensors, and acoustic sensors; and
using the valid sensor data in generating the pre-trained inference model.

6. The method of claim 1, wherein processing the captured output data using the NPU further comprises:
extracting feature data from the output frame and the sound clip; and
generating the pre-trained inference model by applying machine learning techniques to training data that includes the extracted feature data.

7. The method of claim 1, wherein comparing the processed output data with the predetermined safety criteria comprises detecting anomalies selected from the group consisting of missing safety warning elements, extraneous safety warning elements, and inaccurately reproduced auditory signals.

8. The method of claim 1, further comprising:
storing a log of the captured output data and detected deviations; and
using the stored log for subsequent analysis and safety compliance verification.

9. The method of claim 1, wherein reporting the error signal further comprises transmitting the error signal to a fault management module configured to initiate corrective actions.

10. The method of claim 1, wherein issuing the reset command further comprises reinitializing the safety warning sign and sound hardware for a subsequent safety compliance verification cycle.

11. The method of claim 1, wherein the pre-trained inference model is periodically recalibrated based on updated valid sensor data and captured output data from operational cycles to maintain compliance with the predetermined safety criteria.

12. A safety warning sound and graphic sign system for achieving ASIL B or D level, the system comprising:
a predetermined safety warning sign and sound set comprising predetermined graphic symbols and corresponding auditory signals for alerting an operator;
a safety warning sign and sound hardware configured to:
generate the safety warning sign on a display via a display processing unit (DPU) and the safety warning sound through an audio unit (AUD) based on the predetermined safety warning sign and sound set,
compose multiple display layers, and
mix the safety warning sound with a baseline audio signal in a defined ratio;
a neural processing unit (NPU) operatively coupled to the safety warning sign and sound hardware and configured to:
receive output data from the safety warning sign and sound hardware,
process the output data using a pre-trained inference model generated from the predetermined safety warning sign and sound set and valid sensor data, and
identify deviations in the output data from predetermined safety criteria;
a central processing unit (CPU) operatively coupled to the safety warning sign and sound hardware and the NPU, the CPU configured to:
transmit commands to the safety warning sign and sound hardware for generating the safety warning sign and sound in accordance with the predetermined safety warning sign and sound set, and
compare the processed output data from the NPU with the predetermined safety criteria; and
a fault management module operatively coupled to the CPU and the safety warning sign and sound hardware, the fault management module configured to:
receive a deviation signal when the processed output data fails to meet the predetermined safety criteria, and
issue a reset command to the safety warning sign and sound hardware in response.

13. The system of claim 12, further comprising an over-the-air update module configured to automatically download and install updates to the predetermined safety warning sign and sound set based on updated valid sensor data and operational parameters.

14. The system of claim 12, wherein the safety warning sign and sound hardware further comprises:
a mixer circuit configured to mix the safety warning sound with the baseline audio signal at a defined ratio; and
the defined ratio being selected to ensure the audibility of the safety warning sound under varying ambient noise conditions.

15. The system of claim 12, wherein the NPU is further configured to:
extract feature data from the output data received from the safety warning sign and sound hardware; and
use the extracted feature data to enhance the detection of deviations from the predetermined safety criteria.

16. The system of claim 12, wherein the CPU is further configured to recalibrate the pre-trained inference model based on a comparison between the processed output data from the NPU and the predetermined safety criteria.

17. The system of claim 12, wherein the fault management module further comprises:
a logging module configured to record occurrences of deviations detected by the NPU; and
corresponding diagnostic information associated with the recorded occurrences.

18. The system of claim 12, wherein the safety warning sign and sound hardware is further configured to compose multiple display layers, the multiple display layers including:
at least one safety warning graphic layer; and
one informational overlay layer.

19. The system of claim 12, wherein the safety warning sign and sound hardware is integrated within an automotive or robotic control system, the predetermined safety warning sign and sound set being optimized for operative conditions in low-light or high-noise environments.

20. The system of claim 12, wherein the safety warning sign and sound hardware is further configured to automatically adjust the defined mixing ratio of the safety warning sound with the baseline audio signal based on real-time ambient acoustic measurements.

21. The system of claim 12, wherein the NPU is configured to:
receive valid sensor data from at least one sensor selected from the group consisting of cameras, ambient light sensors, and acoustic sensors; and
utilize the pre-trained inference model generated using training data derived from the valid sensor data.
